(19) United States
(12) Patent Application Publication
(10) Pub. No.: US 2017/0310675 A1
(43) Pub. Date: Oct. 26, 2017

(54) SERVER APPARATUS, SYSTEM, INFORMATION PROCESSING METHOD, AND STORAGE MEDIUM STORING COMPUTER PROGRAM

(71) Applicant: CANON KABUSHIKI KAISHA, Tokyo (JP)

(72) Inventor: Junichi Kodama, Tokyo (JP)

(21) Appl. No.: 15/494,269

(22) Filed: Apr. 21, 2017

(30) Foreign Application Priority Data
Apr. 26, 2016 (JP) 2016-088411

(51) Int. Cl. H04L 29/06

(52) U.S. Cl. CPC H04L 63/10; H04L 63/20

(57) ABSTRACT

In a case where a second client apparatus associated with a first client apparatus exists when the first client apparatus is determined as a client apparatus of a transfer target of authority, a server apparatus further determines the second client apparatus as the client apparatus of the transfer target of the authority, generates a permission screen corresponding to a client apparatus determined as the client apparatus of the transfer target of the authority, and transmits the generated permission screen.

### BACKGROUND OF THE INVENTION

### Field of the Invention

The present invention relates to a server apparatus, a system, an information processing method, and a storage medium storing a computer program, which reduce an operation load of a user when transferring authority.

### Description of the Related Art

In recent years, there has been widely provided a service which enables various functions provided by a server apparatus to be used in a user terminal owned by a user via a network. In many cases, when the user terminal requests access to resources retained by the above-described service, the service requests the user terminal to execute user authentication using authentication information such as a user identification (ID) and a password. The user inputs the authentication information to the user terminal. When the authentication has succeeded, an authentication token is issued from the service. The user terminal transmits an execution request of processing to the service together with the issued authentication token attached thereto. The service permits execution of the processing within a range of authority of the user indicated by the authentication token.

Further, the authenticated user may transfer the own authority to a client, so as to make the client acquire the authority to execute the processing. Herein, the client is a server apparatus or a mobile terminal for operating an application in which the resources retained by the service are used. The client is registered in the service as a target of transferring the authority. For example, an authority transfer method using the OAuth 2.0 is widely employed. In the above method, a permission screen for requesting the authenticated user to determine whether to permit the specified authority to the client is provided. When the user selects permission of transferring the authority, an authorization token indicating the authority for accessing the resources is issued to the client. Therefore, the user can transfer the authority for accessing the resources without inputting the own authentication information to the client.

Herein, in the authority transfer method using the OAuth 2.0, the user is requested to determine what authority to be permitted to which client, at each timing at which one client needs authority in order to ensure security of the resources. However, if there is a plurality of clients, the user has to perform a troublesome operation for permitting the authority with respect to each of the clients, and thus there is an issue in which operability thereof will be degraded.

In order to solve the above issue, there is provided a method for simplifying the permission operation of the user.

For example, in a technique discussed in Japanese Patent Application Laid-Open No. 2015-201098, policy information set by a user that is an owner of Web information is previously registered in an authorization server, so that an authorization token is issued based on the policy information when an access request is transmitted from a client used by a transfer target of the authority. With this configuration, the authority can be transferred to the client based on the condition previously set by the user, so that an operation load of the user can be reduced while improving the security.

Further, in a technique discussed in Japanese Patent Application Laid-Open No. 2014-67379, at first, a first authorization token is issued to a device apparatus through permission operation of a user. Then, when the first authorization token is used, a second authorization token is issued to each of applications installed in the device apparatus without making the user perform the permission operation. With this configuration, the operation load of the user can be reduced in a case where more than one applications installed in the device apparatus are regarded as the transfer targets of the authority.

Through the above-described techniques, a load of the permission operation of the user can be reduced when a number of the clients is more than one.

However, with the method of issuing an authorization token based on the pre-registered policy information, it is difficult to cope with the case where the policy information has to be changed. For example, the policy information has to be changed when a client regarded as a transfer target of the authority has been changed or a content of the authority to be transferred to the client has been changed.

Further, with the method of issuing the authorization token to each of the applications based on the authorization token issued to the device apparatus, authority of each of the applications regarded as transfer targets of the authority cannot be provided to the user when the user is requested to make a determination of the permission. Therefore, it is difficult to make determination of the permission of appropriate authority according to the transfer targets of the authority.

### SUMMARY OF THE INVENTION

The present invention is directed to a technique which reduces an operation load of a user when transferring authority while taking the authority of each authority transfer target into account without making the user previously register policy information.

According to an aspect of the present invention, a server apparatus includes a determination unit configured to further determine a second client apparatus as a client apparatus of a transfer target of authority in a case where the second client apparatus associated with a first client apparatus exists when the first client apparatus is determined as the client apparatus of the transfer target of the authority, a generation unit configured to generate a permission screen corresponding to a client apparatus determined as the client apparatus of the transfer target of the authority by the determination unit, and a first transmission unit configured to transmit the permission screen generated by the generation unit.

Further features of the present invention will become apparent from the following description of exemplary embodiments with reference to the attached drawings.

### BRIEF DESCRIPTION OF THE DRAWINGS

FIG. 1 is a block diagram illustrating an example of a system configuration of an authorization system.

FIG. 2 is a block diagram illustrating an example of a hardware configuration of an authorization server.

FIG. 3 is a block diagram illustrating an example of a functional configuration of the authorization system.

FIGS. 4A, 4B, and 4C are tables illustrating examples of information about a user and a group.

FIGS. 5A and 5B are tables illustrating examples of authentication token information and authorization token information.

FIG. 6 is a flowchart illustrating an example of information processing executed by the authorization system.

FIG. 7 is a flowchart illustrating an example of authorization token acquisition processing.

FIGS. 8A, 8B, 8C, and 8D are diagrams illustrating examples of messages.

FIGS. 9A and 9B are diagrams illustrating examples of an authentication screen and an authorization screen.

FIG. 10 is a flowchart illustrating an example of generation processing of a permission screen.

FIG. 11 is a flowchart illustrating an example of generation processing of an authorization token.

FIG. 12 is a flowchart illustrating an example of verification processing of an authorization token.

FIGS. 13A and 13B are flowcharts illustrating examples of discard processing of an authorization token.

FIG. 14 is a diagram illustrating an example of a permission screen.

FIGS. 15A and 15B are diagrams illustrating examples of workflow information and registered client information.

### DESCRIPTION OF THE EMBODIMENTS

Hereinafter, an exemplary embodiment of the present invention will be described with reference to the appended drawings.

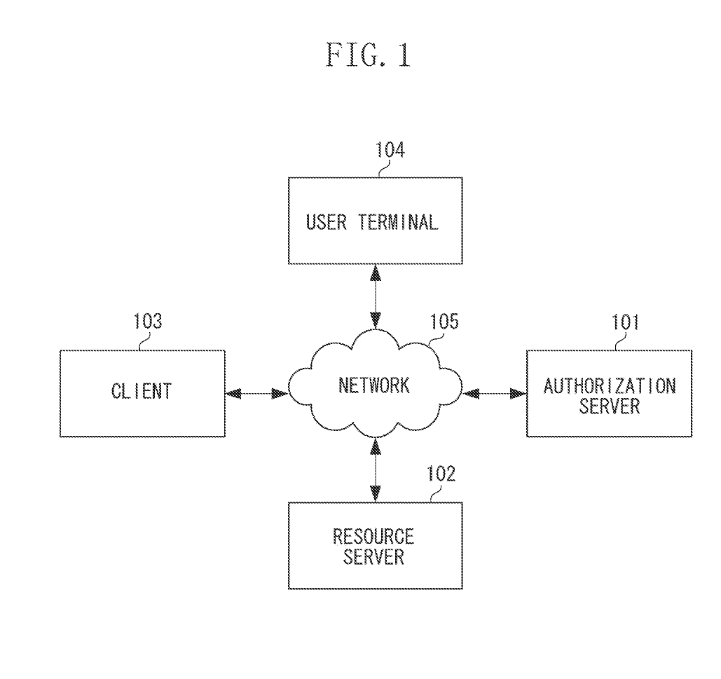

First, a configuration example of an authorization system according to a first exemplary embodiment will be described with reference to FIG. 1.

The authorization system is configured of an authorization server 101, a resource server 102, a client 103, and a user terminal 104. The authorization server 101, the resource server 102, the client 103, and the user terminal 104 can communicate with each other via a network 105. The network 105 may be connected as a single network such as a local area network (LAN), an external network such as the internet, or a network consisting of a combination of the single network and the external network. Further, a plurality of authorization servers 101, a plurality of resource servers 102, and a plurality of clients 103 may be included in the authorization system.

The authorization server 101 manages authority of the user or the client 103 to access the resources retained by the resource server 102. The authorization server 101 retains user information of the user who stores the resource in the resource server 102. Further, the authorization server 101 retains client information of the client 103 that accesses the resources retained by the resource server 102. Furthermore, the authorization server 101 issues an authorization token according to a request from the client 103 and verifies validity of the authorization token according to a request from the resource server 102. Herein, the authorization token refers to data in which authority information given to an authenticated user or authority information transferred to the client 103 from the authenticated user is described. For example, the authorization token may be an access token in the OAuth 2.0. The client 103 acquires an authorization token and transmits the authorization token together with a resource access request when the client 103 makes a request of accessing the resources to the resource server 102. The resource server 102 verifies validity of the received authorization token and judges advisability of the request.

The resource server 102 retains resources of the user. Herein, the resources refer to data or processing of various kinds accessible in the Web. The data of various kinds may be personal data of the user, image data, and document data. Further, the resource server 102 provides the resources according to a resource access request from the client 103. The client 103 is a server or a mobile terminal which operates an application for executing various kinds of processing according to a processing request from the user terminal 104. The client 103 is registered in the authorization server 101 as a transfer target of authority. When processing is to be executed, the client 103 makes a request of accessing the resources necessary for the processing to the resource server 102. Further, in order to make the request of accessing the resources to the resource server 102, the client 103 makes a request of acquiring an authorization token to the authorization server 101.

The user terminal 104 may be a terminal such as a personal computer or a mobile terminal, which is operated by the user.

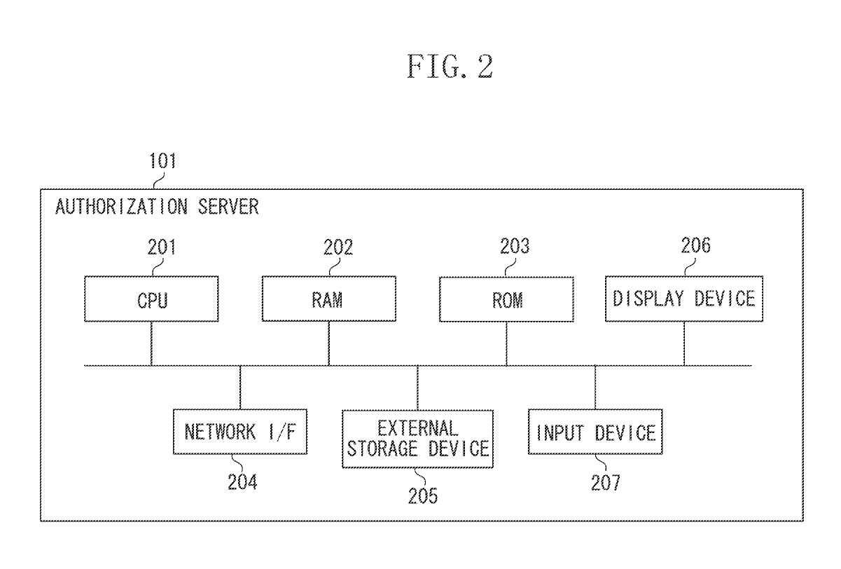

Next, an example of a hardware configuration of the authorization server 101 constituting the authorization system according to the present exemplary embodiment will be described with reference to FIG. 2. In addition, a configuration of the resource server 102, the client 103, or the user terminal 104 is similar to that of the authorization server 101.

The authorization server 101 includes at least a central processing unit (CPU) 201, a random access memory (RAM) 202, a read only memory (ROM) 203, a network interface 204, an external storage device 205, a display device 206, and an input device 207.

The CPU 201 executes operation control of respective units that constitute the authorization server 101, and serves as a unit that mainly executes various kinds of below-described processing regarded as the processing executed by the authorization server 101.

The RAM 202 is a memory which temporarily stores data or control information, which is used as a work area when the CPU 201 executes various kinds of processing.

The ROM 203 stores a fixed operation parameter and a program of the authorization server 101.

The network interface 204 provides a function for executing communication by connecting to the network 105. The authorization server 101 can transmit and receive data to/from an external apparatus through the network interface 204.

The external storage device 205 is a device for storing data, which includes an interface for accepting an input-output (I/O) command for reading and writing data. The external storage device 205 may be a hard disk drive (HDD), a solid state drive (SSD), an optical disk drive, a semiconductor storage device, or a storage device of another type. The external storage device 205 stores a program and data.

For example, the display device 206 is a liquid crystal display (LCD) which displays information necessary for the user.

For example, the input device 207 is a keyboard, a mouse, or a touch panel, which accepts a necessary input from the user.

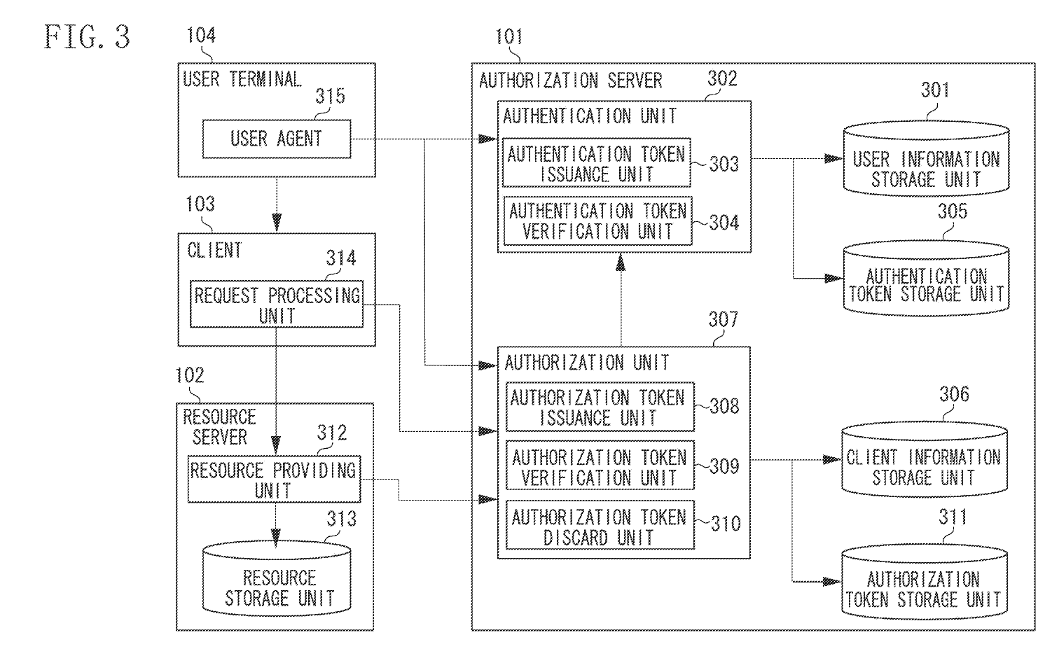

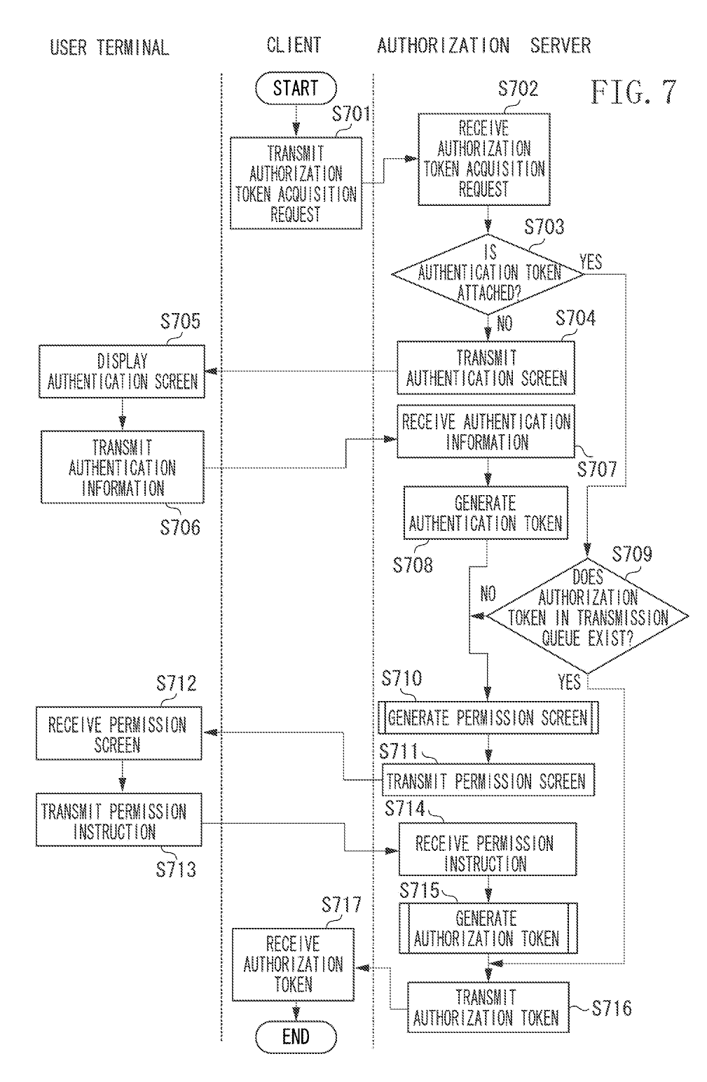

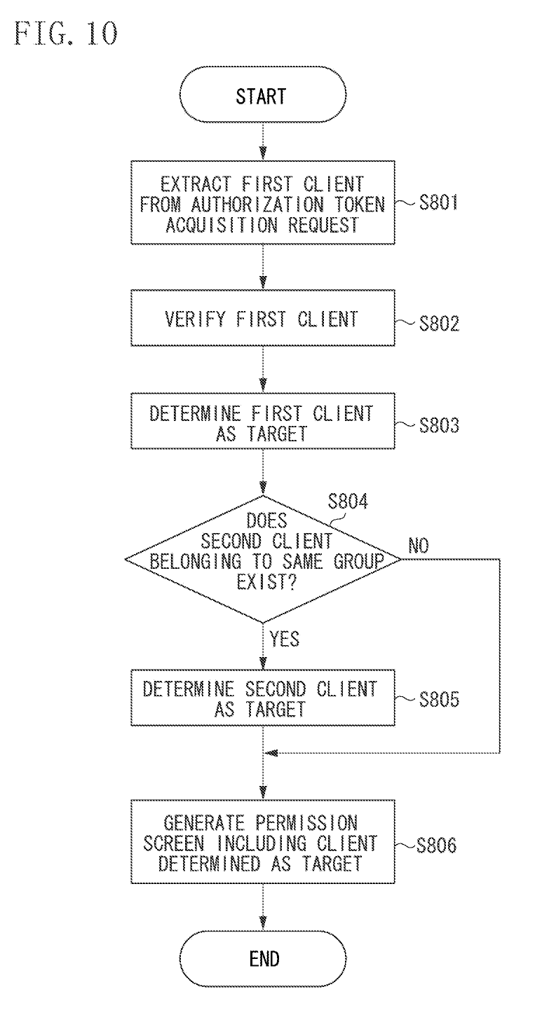

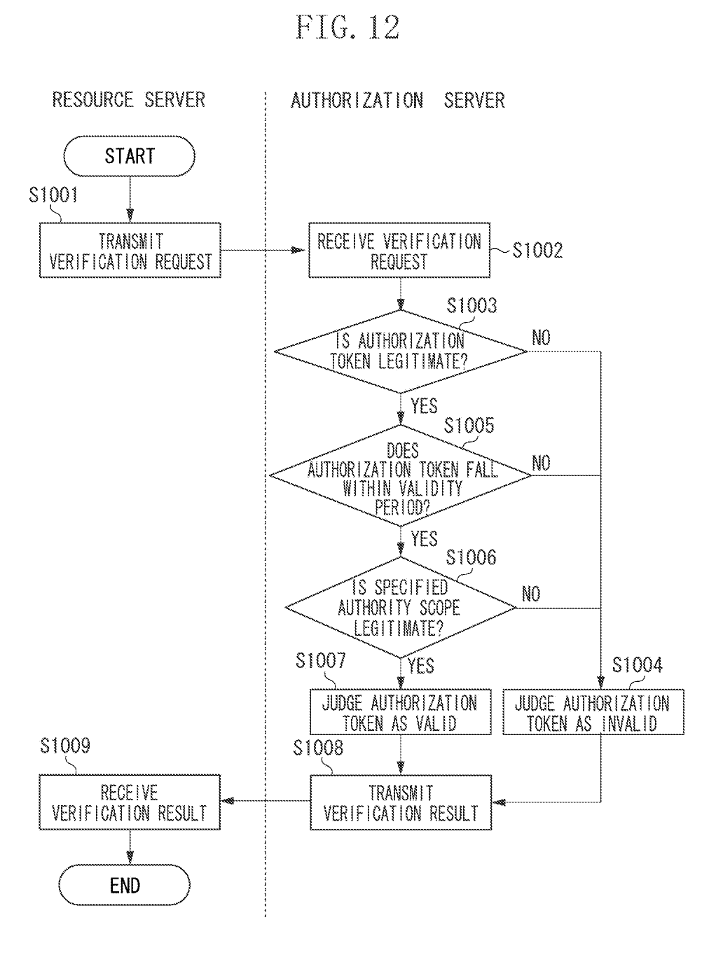

The CPU 201 of the authorization server 101 executes processing based on a program stored in the ROM 203 or the external storage device 205 of the authorization server 101, so as to realize a below-described functional configuration of the authorization server 101 in FIG. 3. Further, the CPU 201 of the authorization server 101 executes processing based on a program stored in the ROM 203 or the external storage device 205 of the authorization server 101, so as to realize the below-described processing illustrated in flowcharts of the authorization server 101 in FIGS. 7 and 12. Furthermore, the CPU 201 of the authorization server 101 executes processing based on a program stored in the ROM 203 or the external storage device 205 of the authorization server 101, so as to realize below-described processing illustrated in flowcharts in FIGS. 10, 11, and 13.

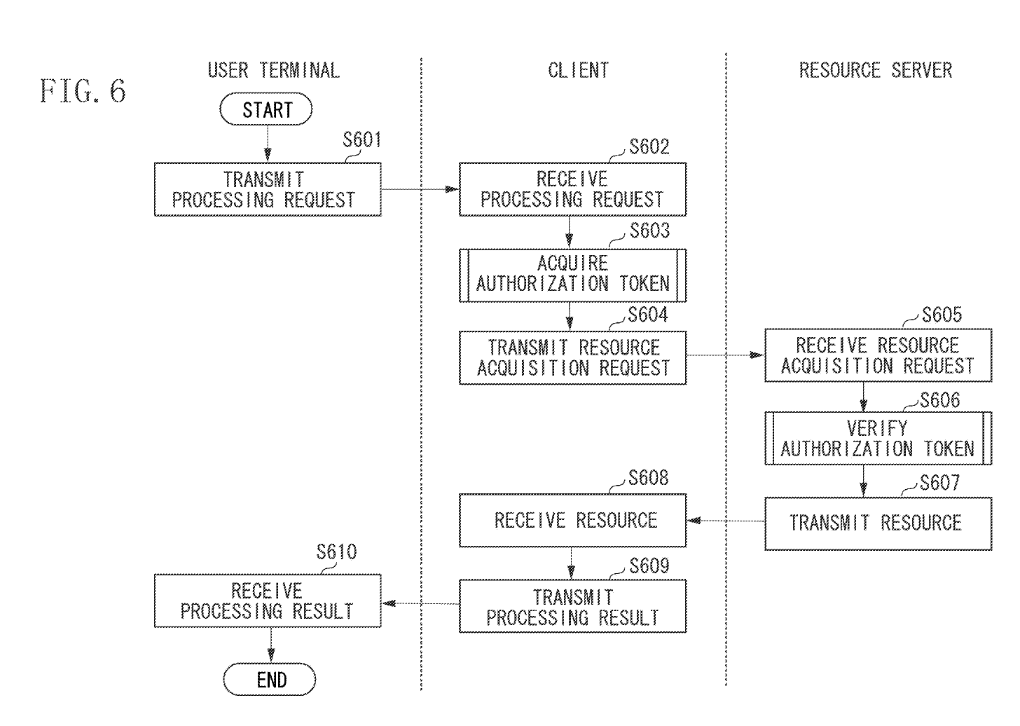

Similarly, a CPU 201 of the resource server 102 executes processing based on a program stored in a ROM 203 or an external storage device 205 of the resource server 102, so as to realize a below-described functional configuration of the resource server 102 in FIG. 3. Further, the CPU 201 of the resource server 102 executes processing based on a program stored in the ROM 203 or the external storage device 205 of the resource server 102, so as to realize the below-described processing illustrated in flowcharts of the resource server 102 in FIGS. 6 and 12.

Similarly, a CPU 201 of the user terminal 104 executes processing based on a program stored in a ROM 203 or an external storage device 205 of the user terminal 104, so as to realize a below-described functional configuration of the user terminal 104 in FIG. 3. Further, the CPU 201 of the user terminal 104 executes processing based on a program stored in the ROM 203 or the external storage device 205 of the user terminal 104, so as to realize the below-described processing illustrated in flowcharts of the user terminal 104 in FIGS. 6 and 7.

Similarly, a CPU 201 of the client 103 executes processing based on a program stored in a ROM 203 or an external storage device 205 of the client 103, so as to realize a below-described functional configuration of the client 103 in FIG. 3. Further, the CPU 201 of the client 103 executes processing based on a program stored in the ROM 203 or the external storage device 205 of the client 103, so as to realize the below-described processing illustrated in flowcharts of the client 103 in FIGS. 6 and 7.

Next, an example of a functional configuration of the authorization system according to the present exemplary embodiment will be described with reference to FIG. 3. The authorization server 101 includes an authentication unit 302, an authorization unit 307, a user information storage unit 301, an authentication token storage unit 305, a client information storage unit 306, and an authorization token storage unit 311. The authentication unit 302 includes an authentication token issuance unit 303 and an authentication token verification unit 304. The authorization unit 307 includes an authorization token issuance unit 308, an authorization token verification unit 309, and an authorization token discard unit 310.

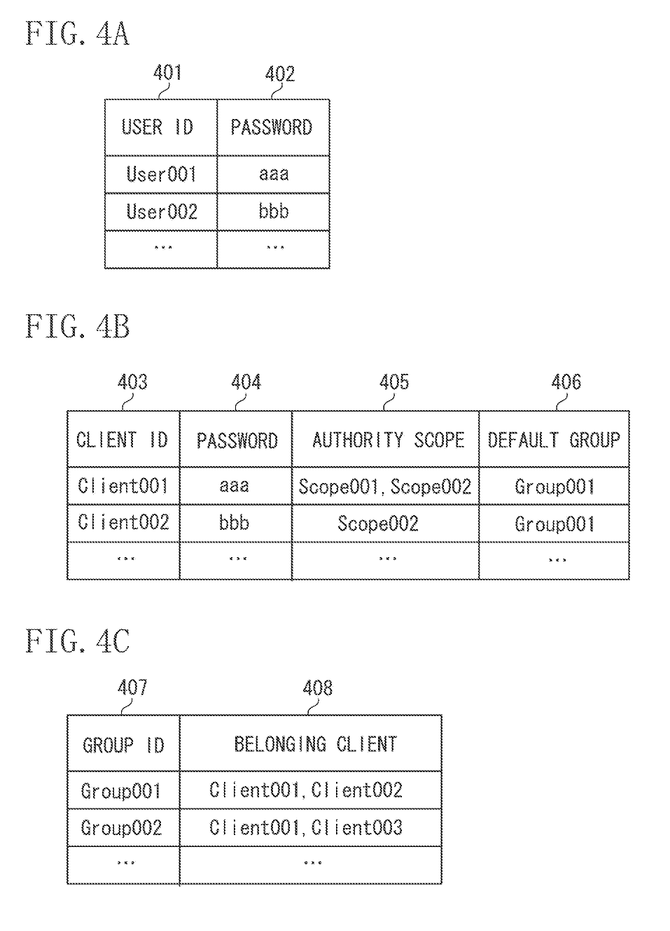

The user information storage unit 301 stores user information for authenticating the user. An example of the user information stored in the user information storage unit 301 is illustrated in FIG. 4A. A password 402 is stored in association with a user identification (ID) 401. The user ID 401 uniquely identifies a user who stores resources in the resource server 102. The password 402 is a character string for verifying the identity of the user. Herein, although the password 402 is used for authenticating the user, another authentication information may be used.

When an authentication token issuance request is transmitted from an external apparatus, the authentication token issuance unit 303 authenticates the user based on the user information stored in the user information storage unit 301 and issues an authentication token. The issued authentication token is stored in the authentication token storage unit 305.

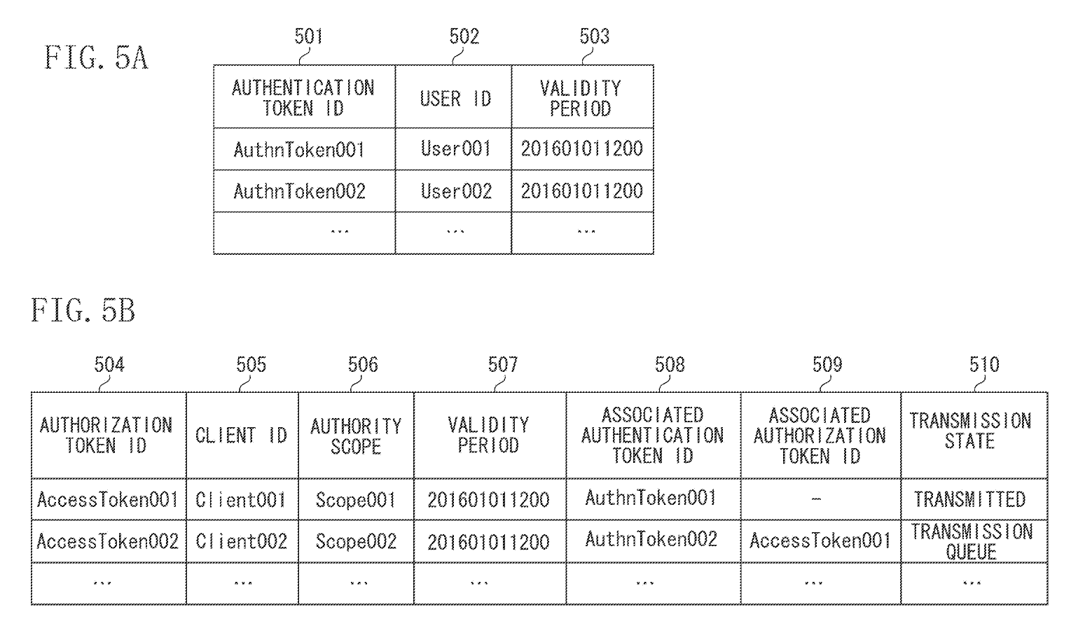

An example of the authentication token information stored in the authentication token storage unit 305 is illustrated in FIG. 5A. A user ID 502 and a validity period 503 are stored in association with an authentication token ID 501. The user ID 502 represents an authenticated user. The validity period 503 is a validity period of the authentication token, and the authentication token that exceeds the validity period becomes invalid.

The authentication token verification unit 304 verifies legitimacy of the authentication token based on the authentication token information stored in the authentication token storage unit 305.

The client information storage unit 306 stores client information and group information of the client 103 which are necessary for transferring the authority to the client 103.

An example of the client information stored in the client information storage unit 306 is illustrated in FIG. 4B. A password 404, an authority scope 405, and a default group 406 are stored in association with a client ID 403. The client ID 403 uniquely identifies the client 103. The password 404 is a character string for authenticating the client 103. Herein, although the password 404 is used for authenticating the client 103, another authentication information may be used. The authority scope 405 represents an application range of the authority retained by the client 103. The default group 406 represents an initial setting value of the group which the client 103 belongs to.

An example of group information of the client 103 stored in the client information storage unit 306 is illustrated in FIG. 4C. A belonging client 408 is stored in association with a group ID 407. The group ID 407 uniquely identifies a group which the client 103 belongs to. The belonging client 408 represents a client ID 403 of the client 103 belonging to that group.

The authorization token issuance unit 308 issues an authorization token based on a permission of the user authenticated by the authentication token issuance unit 303 when an authorization token issuance request is transmitted from an external apparatus. At this time, the authorization token issuance unit 308 verifies validity of the client 103 regarded as a transfer target of the authority based on the client information stored in the client information storage unit 306. The issued authorization token is stored in the authorization token storage unit 311. An example of the authorization token information stored in the authorization token storage unit 311 is illustrated in FIG. 5B. A client ID 505, an authority scope 506, a validity period 507, an associated authentication token ID 508, and an associated authorization token ID 509 are stored in association with an authorization token ID 504. The client ID 505 represents the client 103 to which the authority is transferred (i.e., an authorization token is issued). The authority scope 506 represents an application range of the authority retained by the authorization token. The validity period 507 is a validity period of the authorization token, and the authorization token that exceeds the validity period becomes invalid. The associated authentication token ID 508 represents an authentication token of the user who permits transfer of the authority. The associated authorization token ID 509 represents another authorization token generated simultaneously with that authorization token. A transmission status 510 indicates whether the authorization token has been transmitted to the client 103 regarded as a target.

The authorization token verification unit 309 verifies legitimacy of the authorization token based on the authentication token information stored in the authorization token storage unit 311 when an authorization token verification request is transmitted from an external apparatus.

The authorization token discard unit 310 discards the authorization token stored in the authorization token storage unit 311 when an authorization token discard request is transmitted from an external apparatus.

The resource server 102 includes a resource providing unit 312 and a resource storage unit 313. The resource storage unit 313 stores resources owned by the user. The resource providing unit 312 provides the resources stored in the resource storage unit 313 when a resource acquisition request is transmitted from an external device. At this time, the resource providing unit 312 inquires of the authorization token verification unit 309 of the authorization server 101 about whether the authorization token attached to the resource acquisition request retains authority with respect to the resources, and verifies whether the authorization token is valid.

The client 103 includes a request processing unit 314.

According to a processing request from the user terminal 104, the request processing unit 314 transmits a resource providing request to the resource server 102 and acquires the resources necessary for the processing. The request processing unit 314 attaches the authorization token acquired from the authorization token issuance unit 308 of the authorization server 101 to the resource providing request.

The user terminal 104 includes a user agent 315.

The user agent 315 provides a function such as a web browser function which allows a user to access a web site.

Next, description of operation of the authorization system according to the present exemplary embodiment as well as an authorization method according to the present exemplary embodiment will be given.

FIG. 6 is a flowchart illustrating an example of information processing of the authorization system according to the present exemplary embodiment. In the present exemplary embodiment, although a server that provides a web application is assumed as the client 103, the client 103 is not limited to the above, and the client 103 may be an application of a mobile terminal.

First, in step S601, according to a user operation, the user agent 315 of the user terminal 104 receives a processing request with respect to the client 103 and transmits a processing request to the client 103. In step S602, the request processing unit 314 of the client 103 receives the processing request. In step S603, if the resources retained by the resource server 102 are necessary for executing the processing, the request processing unit 314 acquires an authorization token from the authorization server 101. Acquisition processing of the authorization token will be described below with reference to FIG. 7. If the authorization token can be acquired, in step S604, the request processing unit 314 transmits a resource acquisition request to which the authorization token is attached, to the resource server 102. In step S605, the resource providing unit 312 of the resource server 102 receives the resource acquisition request. In step S606, the resource providing unit 312 verifies whether the authorization token attached to the resource providing request is valid. Verification processing of the authorization token will be described below with reference to FIG. 12. If the authorization token is valid, in step S607, the resource providing unit 312 transmits the resources to the client 103. In step S608, the request processing unit 314 of the client 103 receives the transmitted resources. In step S609, the resource processing unit 314 executes processing corresponding to the processing request by using the received resources and transmits the processing result to the user terminal 104. In step S610, the user agent 315 of the user terminal 104 receives the processing result and provides the processing result to the user by displaying the processing result on the display device 206 of the user terminal 104.

Next, acquisition processing of the authorization token executed by the authorization system according to the present exemplary embodiment will be described with reference to FIG. 7. Although the processing flow based on the protocol of the OAuth 2.0 is illustrated in FIG. 7, another protocol having the similar processing flow may be employed.

First, in step S701, the request processing unit 314 of the client 103 transmits an authorization token acquisition request to the authorization server 101. The authorization token acquisition request is practically transmitted to the authorization server 101 from the client 103 via the user terminal 104.

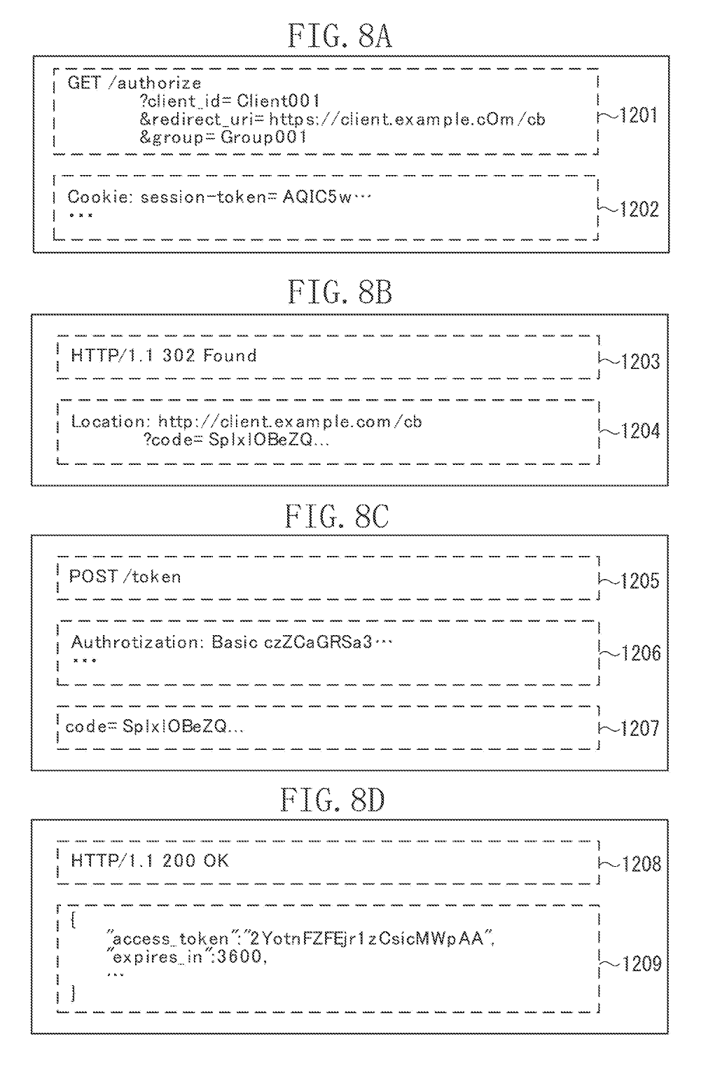

An example of a message described in the authorization token acquisition request is illustrated in FIG. 8A. In FIG. 8A, a message is formed in a syntax according to the hypertext transfer protocol (HTTP). In a uniform resource locator (URL) portion 1201, a destination of the request is specified, and a client ID of the client 103 is specified as a URL parameter at a trailing end thereof. With this information, the authorization server 101 can specify which client 103 transmits the authorization token acquisition request. Further, a group ID of the client 103 is specified as the URL parameter. With this information, the authorization server 101 can specify with respect to what client 103 of which group permission determination is collectively requested and the authorization token is generated. The authentication information of the user of which the permission determination is requested is specified in a header portion 1202.

In step S702, the authorization token issuance unit 308 of the authorization server 101 receives the authorization token acquisition request transmitted from the client 103. In step S703, the authorization token issuance unit 308 judges whether a user who gives permission for issuing the authorization token has been authenticated. The authorization token issuance unit 308 judges whether the authentication token is attached to the authorization token acquisition request and whether the attached authentication token is valid, so as to judge whether the user has been authenticated. If the authorization token issuance unit 308 judges that the user has not been authenticated (NO in step S703), the processing proceeds to step S704. In step S704, the authorization token issuance unit 308 transmits an authentication screen for requesting the user to perform authentication to the user terminal 104.

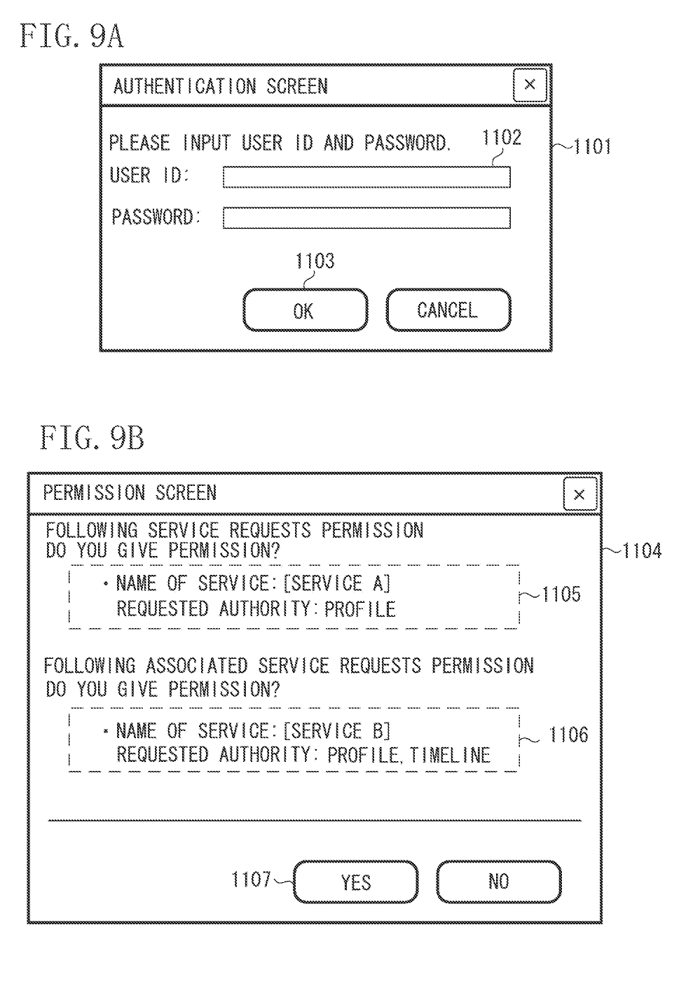

An example of the authentication screen is illustrated in FIG. 9A. An authentication screen 1101 consists of a region 1102 for inputting authentication information of the user (e.g., a user ID and a password) and a button 1103 for confirming and transmitting the input authentication information to the authorization server 101.

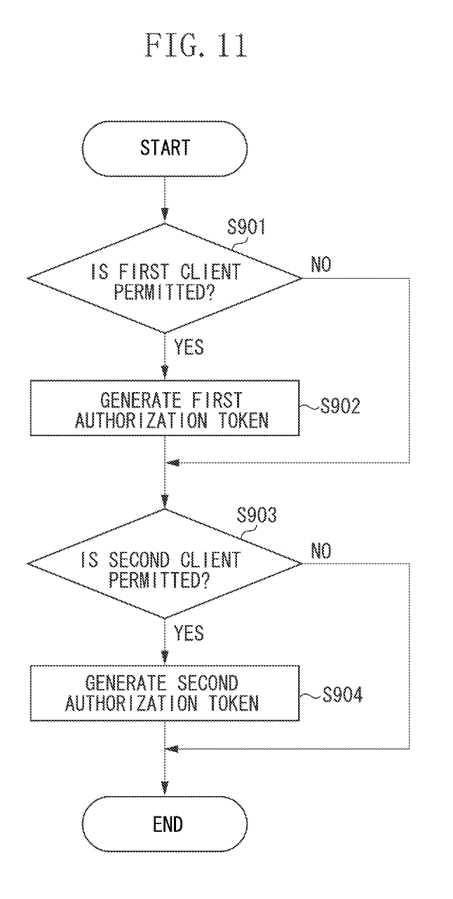

In step S705, the user agent 315 of the user terminal 104 receives the authentication screen transmitted from the authorization server 101 and displays the authentication screen on the display device 206. In step S706, the user agent 315 accepts the authentication information input by the user via the input device 207 and transmits the authentication information to the authorization server 101. In step S707, the authentication token issuance unit 303 of the authorization server 101 receives the authentication information. In step S708, the authentication token issuance unit 303 issues an authentication token when authentication using the received authentication information has succeeded. The authentication token issuance unit 303 attaches the issued authentication token to the authorization token acquisition request and transmits that authorization token acquisition request to the authorization token issuance unit 308. Then, in step S710, the authorization token issuance unit 308 generates a permission screen for requesting the authenticated user to perform permission determination. Generation processing of the permission screen will be described below with reference to FIG. 10. In step S711, the authorization token issuance unit 308 transmits the generated permission screen to the user terminal 104. On the other hand, if the authorization token issuance unit 308 judges that the user has been authenticated already (YES in step S703), the processing proceeds to step S709. In step S709, the authorization token issuance unit 308 verifies whether the authorization token associated with the authentication token which is in a transmission queue exists. If the authorization token in a transmission queue does not exist (NO in step S709), the processing proceeds to step S710. In step S710, the authorization token issuance unit 308 similarly generates the permission screen. In step S712, the user agent 315 of the user terminal 104 receives the permission screen transmitted from the authorization server 101 and displays the permission screen on the display device 206. In step S713, the user agent 315 accepts input of a permission instruction according to a user operation via the input device 207, and transmits the permission determination information to the authorization server 101. In step S714, the authorization token issuance unit 308 of the authorization server 101 receives the permission determination information. In step S715, the authorization token issuance unit 308 generates an authorization token based on the permission determination information. Generation processing of the authorization token will be described below with reference to FIG. 11.

In step S716, from among the generated authorization tokens, the authorization token issuance unit 308 transmits the authorization token a client 103 of which is specified as a transfer target of the authority in the authorization token acquisition request, to that client 103, and sets the transmission state as “transmitted”. On the other hand, if the authorization token in a transmission queue exists (YES in step S709), the processing proceeds to step S716. Then, in step S716, the authorization token issuance unit 308 transmits that authorization token and sets the transmission state as “transmitted”. In step S717, the request processing unit 314 of the client 103 receives the authorization token. Practically, the processing in steps S716 and S717 is executed in such a manner that an authorization result including tentative authorization information is firstly transmitted to the client 103 via the user terminal 104. Then, the client 103 acquires the authorization token from the authorization server 101 by using the tentative authorization information.

An example of a message of the authorization result is illustrated in FIG. 8B. FIG. 8B is a diagram illustrating a message formed as an HTTP response. A status indicating a result of the authorization request is set to a status portion 1203. Further, tentative authorization information is included in a header portion 1204. The tentative authorization information is used when the client 103 acquires the authorization token.

FIG. 8C is a diagram illustrating an example of a message of the authorization token acquisition request using the tentative authorization information. In FIG. 8C, a message is formed in a syntax according to the HTTP protocol. A destination of the request is specified in a URL portion 1205. The authentication information of the client 103 is specified in a header portion 1206. With this information, the authorization server 101 can permit execution of the request only to the client 103 that has succeeded in authentication. The tentative authorization information is specified in a body portion 1207.

An example of a message of the authorization token transmitted to the client 103 is illustrated in FIG. 8D. In FIG. 8D, a message is formed as an HTTP response. A status indicating that the authorization token acquisition request has succeeded is set to a status portion 1208. An authorization token and a validity period of the authorization token are set to a body portion 1209.

As described above, in the acquisition processing of the authorization token according to the present exemplary embodiment, the authorization server 101 requests the authenticated user to perform permission determination, generates an authorization token representing transferred authority based on the permission determination performed by the user, and transmits the authorization token to the client 103. Further, if the authorization token is generated previously, the authorization server 101 transmits the authorization token to the client 103 without requesting the user to perform permission determination.

Next, generation processing of the permission screen executed by the authorization server 101 according to the present exemplary embodiment will be described with reference to a flowchart of the processing illustrated in FIG. 10.

In step S801, the authorization token issuance unit 308 extracts a client specified by the authorization token acquisition request as a first client. In step S802, the authorization token issuance unit 308 verifies whether the first client is legitimate, by using the client information stored in the client information storage unit 306. If the first client is legitimate, the authorization token issuance unit 308 determines the first client as a transfer target of the authority. Next, in step S804, the authorization token issuance unit 308 verifies whether a second client that belongs to a group the same as that of the first client exists, by using the group information of the client stored in the client information storage unit 306. The authorization token issuance unit 308 judges a target group from a group ID specified in the authorization token issuance request. If the group ID is not included in the authentication token issuance request (NO in step S804), the authorization token issuance unit 308 uses the default group ID set to the first client information. If the group ID is included (YES in step S804), the processing proceeds to step S805. In step S805, the authorization token issuance unit 308 determines the second client as a transfer target of the authority. Herein, although just one client is described as the second client, the authorization token issuance unit 308 determines all of the clients 103 that belong to the same group as the second clients. At this time, the authorization token issuance unit 308 may eliminate the client 103 that retains the authorization token of the same user and the same authority scope, from the second client. Lastly, in step S806, the authorization token issuance unit 308 generates a permission screen for requesting permission determination to the client determined as a transfer target of the authority.

An example of the permission screen is illustrated in FIG. 9B. A permission screen 1104 consists of a list 1105 of the authority scope transferred to the first client, a list 1106 of the authority scope transferred to the second client, and a button 1107 for confirming whether to give permission.

As described above, in the generation processing of the permission screen according to the present exemplary embodiment, the authorization server 101 collectively requests the user to perform permission determination with respect to the second client that belongs to the group the same as that of the first client in addition to the first client specified by the authorization token acquisition request.

Next, generation processing of the authorization token executed by the authorization server 101 according to the present exemplary embodiment will be described with reference to a flowchart of the processing illustrated in FIG. 11.

First, in step S901, the authorization token issuance unit 308 judges whether the first client is permitted by the permission determination information received from the user terminal 104. If the first client is permitted (YES in step S901), the processing proceeds to step S902. In step S902, the authorization token issuance unit 308 generates a first authorization token with respect to the first client. The issued first authorization token is stored in the authorization token storage unit 311. At this time, a transmission state of the first authorization token is set as “transmission queue”. On the other hand, if the first client is not permitted (NO in step S901), the processing proceeds to step S903. In step S903, the authorization token issuance unit 308 judges whether the second client is permitted by the permission instruction. If the second client is permitted (YES in step S903), the processing proceeds to step S904. In step S904, the authorization token issuance unit 308 generates the second authorization token with respect to the second client. The issued second authorization token is stored in the authorization token storage unit 311 in association with the authentication token attached to the permission determination information and the first authorization token. At this time, a transmission state of the second authorization token is set as “transmission queue”. If the second client is not permitted (NO in step S903), the authorization token issuance unit 308 ends the processing illustrated in FIG. 11.

In the generation processing of the authorization token according to the present exemplary embodiment, based on the permission determination information received from the user terminal 104, the authorization tokens are collectively generated with respect to the first client specified by the authorization token acquisition request as well as the second client that belongs to the group the same as that of the first client.

Next, verification processing of the authorization token executed by the authorization system according to the present exemplary embodiment will be described with reference to a flowchart of the processing illustrated in FIG. 12.

First, in step S1001, the resource providing unit 312 of the resource server 102 transmits an authorization token verification request to the authorization server 101. In step S1002, the authorization token verification unit 309 of the authorization server 101 receives the authorization token verification request. In step S1003, the authorization token verification unit 309 judges whether the authorization token attached to the authorization token verification request is legitimate. The authorization token verification unit 309 judges whether the authorization token is stored in the authorization token storage unit 311, so as to judge whether the authorization token is legitimate. If the authorization token is judged as illegitimate (NO in step S1003), the processing proceeds to step S1004. In step S1004, the authorization token verification unit 309 judges that the authorization token is invalid. If the authorization token is judged as legitimate (YES in step S1003), the processing proceeds to step S1005. In step S1005, the authorization token verification unit 309 judges whether the authorization token falls within a validity period. If the authorization token verification unit 309 judges that the authorization token exceeds the validity period (NO in step S1005), the processing proceeds to step S1004. In step S1004, the authorization token verification unit 309 judges that the authorization token is invalid. If the authorization token verification unit 309 judges that the authorization token falls within the validity period (YES in step S1005), the processing proceeds to step S1006. In step S1006, the authorization token verification unit 309 judges whether the authority scope specified by the authorization token verification request is legitimate. The authorization token verification unit 309 judges whether the authority scope is associated with the authorization token in the authorization token storage unit 311, so as to judge whether the authority scope is legitimate. If the authority scope is judged as illegitimate (NO in step S1006), the processing proceeds to step S1004. In step S1004, the authorization token verification unit 309 judges that the authorization token is invalid. If the authority scope is judged as legitimate (YES in step S1006), the processing proceeds to step S1007. In step S1007, the authorization token verification unit 309 judges that the authorization token is valid. In step S1008, the authorization token verification unit 309 transmits the verification result to the resource server 102. In step S1009, the resource providing unit 312 of the resource server 102 receives the verification result.

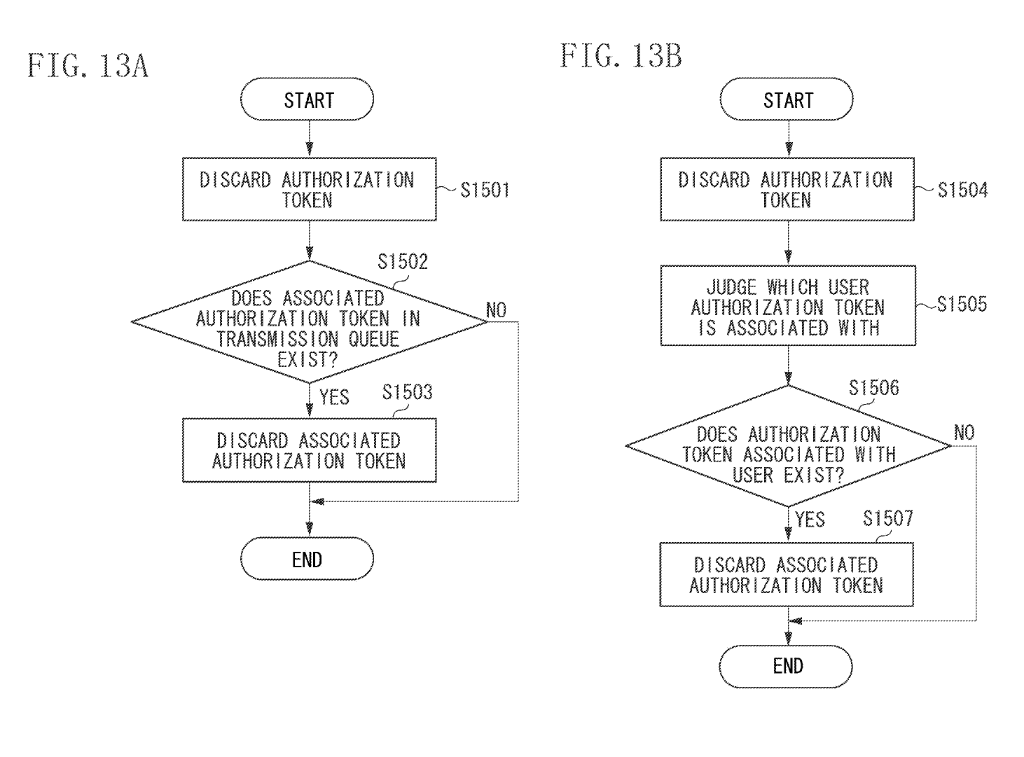

Next, discard processing of the authorization token executed by the authorization server 101 according to the present exemplary embodiment will be described with reference to a flowchart of the processing illustrated in FIG. 13A. The discard processing of the authorization token is executed when an authorization token discard request is transmitted from an external apparatus, or may be executed as periodical batch processing for discarding the expired authorization token.

First, in step S1501, the authorization token discard unit 310 deletes a discard target authorization token from the authorization token storage unit 311. The discard target authorization token is an authorization token specified by the authorization token discard request or an authorization token judged as expired in the batch processing. Next, in step S1502, the authorization token discard unit 310 verifies whether another authorization token a transmission state of which is “transmission queue” exists in the other authorization tokens associated with the discard target authorization token. If the authorization token in a transmission queue exists (YES in step S1502), the processing proceeds to step S1503. In step S1503, the authorization token discard unit 310 deletes the authorization token from the authorization token storage unit 311. If the authorization token in a transmission queue does not exist (NO in step S1502), the authorization token discard unit 310 ends the processing illustrated in FIG. 13A.

As described above, in the discard processing of the authorization token according to the present exemplary embodiment, the second authorization token generated simultaneously with the first authorization token is also discarded if the second authorization token is in “transmission queue” when the first authorization token is to be discarded.

In the present exemplary embodiment, although the second authorization token is discarded when the transmission state thereof is “transmission queue”, the second authorization token may be discarded regardless of the transmission state.

According to the authorization system of the present exemplary embodiment, request of permission determination or generation of authorization tokens with respect to the clients belonging to the same group can be executed collectively. Therefore, a load of permission operation performed by the user can be reduced through a method which takes permission of authority with respect to each client into consideration.

In the generation processing of the permission screen described in the first exemplary embodiment, permission determination has been collectively requested with respect to the first and the second clients. In a second exemplary embodiment, what authority to be permitted to which client is selectable when the permission determination is requested collectively.

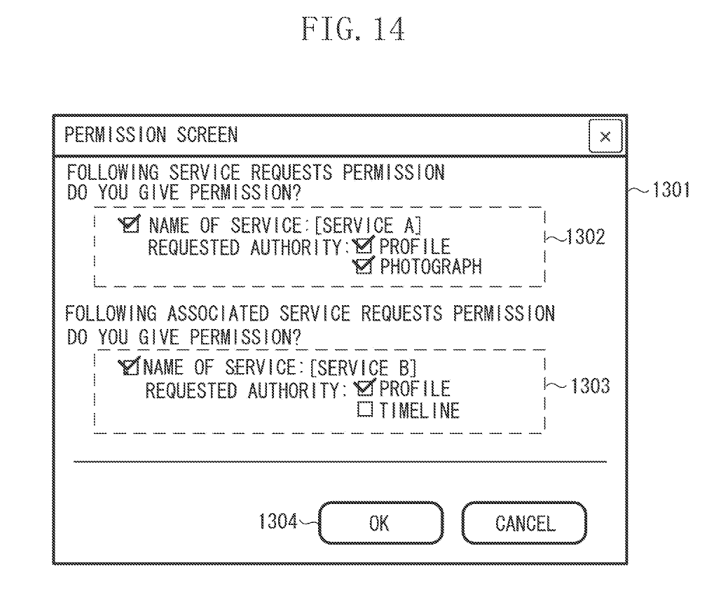

An example of the permission screen generated by the authorization token issuance unit 308 of the authorization server 101 according to the present exemplary embodiment is illustrated in FIG. 14. A permission screen 1301 consists of a list 1302 of authority scopes transferred to a first client, a list 1303 of authority scopes transferred to the second client, and a button 1304 for confirming the permission determination. The lists 1302 and 1303 of authority scopes include checkboxes which enable a user to select whether to permit respective clients and what authority scopes to be permitted to the respective clients. The checkbox is an example of an object which enables the user to select whether to permit the authority scope.

As described above, in the generation processing of the permission screen according to the present exemplary embodiment, when the permission determination is collectively executed with respect to the first and the second clients, it is possible to select the client and authority to be permitted. Therefore, the user can collectively perform permission determination more flexibly.

In the generation processing of the permission screen described in the first exemplary embodiment, clients 103 that belong to the same group are judged as the second clients, and permission determination has been requested collectively. In a third exemplary embodiment, the second client is judged based on pre-set workflow information.

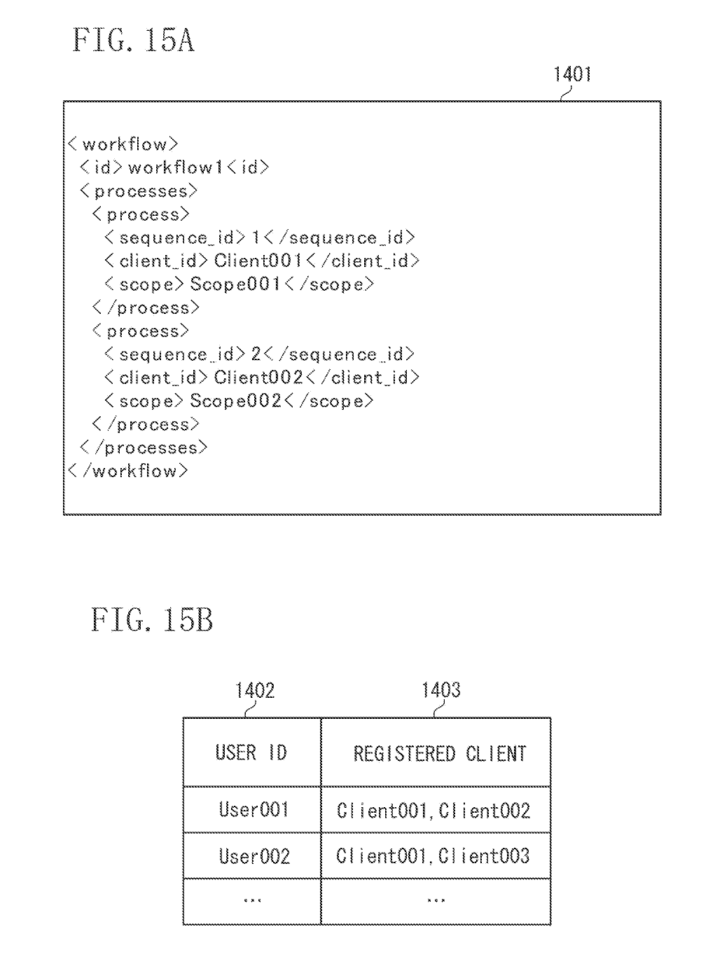

An example of the workflow information stored in the client information storage unit 306 of the authorization server 101 according to the present exemplary embodiment is illustrated in FIG. 15A. In workflow information 1401, an execution sequence of clients and necessary authority scopes are defined in association with workflow IDs. The client 103 specifies a target workflow ID and transmits an authentication token acquisition request. The authorization token issuance unit 308 of the authorization server 101 judges the client defined in the specified workflow as the second client and generates a permission screen.

As described above, in the generation processing of the permission screen according to the present exemplary embodiment, the second client is judged based on the workflow. Therefore, permission determination can be collectively requested while taking association between the clients into consideration.

In the generation processing of the permission screen described in the first exemplary embodiment, the client 103 that belongs to the same group has been judged as the second client, and permission determination has been requested collectively. In a fourth exemplary embodiment, the client 103 associated with the user is judged as the second client.

Registered client information stored in the client information storage unit 306 of the authorization server 101 according to the present exemplary embodiment is illustrated in FIG. 15B. A registered client 1403 is stored in association with a user ID 1402. The authorization unit 307 may register the registered client 1403 based on user operation performed via the input device 207, or may register the registered client 1403 based on an access history of the user with respect to the client 103. The authorization token issuance unit 308 of the authorization server 101 judges the client 103 registered as the registered client 1403 as the second client and generates the permission screen.

As described above, in the generation processing of the permission screen according to the present exemplary embodiment, the client 103 associated with the user is judged as the second client. Therefore, it is possible to collectively request permission determination while taking characteristics of the user into consideration.

In the discard processing of the authorization token described in the first exemplary embodiment, the second authorization token generated simultaneously with the first authorization token has been also discarded when the first authorization token is discarded. In a fifth exemplary embodiment, when an authorization token is discarded, a user who performs permission determination of that authorization token is judged, and another authorization token associated with that user is also discarded.

The discard processing of the authorization token executed by the authorization server 101 according to the present exemplary embodiment will be described with reference to a flowchart of the processing illustrated in FIG. 13B. First, in step S1504, the authorization token discard unit 310 deletes a discard target authorization token from the authorization token storage unit 311. Next, in step S1505, the authorization token discard unit 310 judges which user the discard target authorization token is associated with. The authorization token discard unit 310 specifies an associated authentication token based on the associated authentication token ID 508 stored in the authorization token storage unit 311, and specifies and judges the user based on the user ID 502 stored in the authentication token storage unit 305. Next, in step S1506, the authorization token discard unit 310 verifies whether an authorization token associated with that user exists. If the authorization token associated with the user exists (YES in step S1506), the processing proceeds to step S1507. In step S1507, the authorization token discard unit 310 deletes the authorization token from the authorization token storage unit 311. On the other hand, if the authorization token associated with the user does not exist (NO in step S1506), the authorization token discard unit 310 ends the processing illustrated in FIG. 13B.

As described above, in the discard processing of the authorization token according to the present exemplary embodiment, another authorization token associated with the same user is also discarded when the authorization token is deleted. Therefore, the authorization tokens associated with the user can be discarded collectively.

### Other Exemplary Embodiments

In the present invention, a program for realizing one or more functions according to the above-described exemplary embodiments is supplied to a system or an apparatus via a network or a storage medium. Then, the present invention can be realized with processing in which one or more processors in the system or the apparatus read and execute the program. Further, the present invention can be also realized with a circuit (e.g., application specific integrated circuit (ASIC)) that realizes one or more functions.

Although the preferred exemplary embodiments of the present invention have been described as the above, the present invention is not limited to the specific exemplary embodiments. The processing of the above-described exemplary embodiments has been described as a structure according to the protocol of the OAuth 2.0. However, a structure of the processing of the above-described exemplary embodiment is not limited to the structure according to the protocol of the OAuth 2.0. Further, the above-described exemplary embodiments may be carried out by optionally combining with each other.

As described above, according to the above-described exemplary embodiments, it is possible to provide a technique which reduces an operation load of a user when transferring authority while taking authority of each authority transfer target into account without making the user previously register policy information.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-088411, filed Apr. 26, 2016, which is hereby incorporated by reference herein in its entirety.

What is claimed is:

1. A server apparatus comprising:
a determination unit configured to further determine a second client apparatus as a client apparatus of a transfer target of authority in a case where the second client apparatus associated with a first client apparatus exists when the first client apparatus is determined as the client apparatus of the transfer target of the authority;
a generation unit configured to generate a permission screen corresponding to a client apparatus determined as the client apparatus of the transfer target of the authority by the determination unit; and
a first transmission unit configured to transmit the permission screen generated by the generation unit.

2. The server apparatus according to claim 1, further comprising a receiving unit configured to receive an authorization token acquisition request from a client apparatus,
wherein, in a case where the second client apparatus associated with the first client apparatus exists when the first client apparatus is determined as the client apparatus of the transfer target of the authority based on client information of the client apparatus included in the authorization token acquisition request received by the receiving unit, the determination unit further determines the second client apparatus as the client apparatus of the transfer target of the authority.

3. The server apparatus according to claim 1, further comprising a judgement unit configured to judge whether the second client apparatus associated with the first client apparatus exists,
wherein, in a case where the judgement unit judges that the second client apparatus associated with the first client apparatus exists, the determination unit further determines the second client apparatus as the client apparatus of the transfer target of the authority.

4. The server apparatus according to claim 3, wherein, in a case where a client apparatus that belongs to a group same as a group to which the first client apparatus belongs exists, the judgement unit judges that the second client apparatus associated with the first client apparatus exists.

5. The server apparatus according to claim 3, wherein, in a case where a client apparatus which executes processing subsequent to the first client apparatus is defined by workflow information, the judgement unit judges that the second client apparatus associated with the first client apparatus exists.

6. The server apparatus according to claim 3, wherein, in a case where a client apparatus a user of which is same as a user of the first client apparatus exists, the judgement unit judges that the second client apparatus associated with the first client apparatus exists.

7. The server apparatus according to claim 1, wherein an authority scope transferred to the first client apparatus and an authority scope transferred to the second client apparatus are included in the permission screen.

8. The server apparatus according to claim 7, wherein an object that enables a user to select whether to permit each of the authority scopes is included in the permission screen.

9. The server apparatus according to claim 1, wherein the first transmission unit transmits the permission screen to a user terminal apparatus.

10. The server apparatus according to claim 1, further comprising:
an issuance unit configured to issue an authorization token of the first client apparatus and an authorization token of the second client apparatus in a case where a permission instruction is received via the permission screen; and
a second transmission unit configured to transmit the authorization token of the first client apparatus and the authorization token of the second client apparatus issued by the issuance unit.

11. The server apparatus according to claim 10, further comprising a storage unit configured to store the authorization token of the first client apparatus and the authorization token of the second client apparatus issued by the issuance unit in association with each other.

12. The server apparatus according to claim 11, further comprising a deletion unit configured to delete a second authorization token in a case where the second authorization token that is in a transmission queue exists in authorization tokens stored in association with a first authorization token, in the storage unit when the first authorization token is to be deleted.

13. The server apparatus according to claim 11, further comprising a deletion unit configured to delete a second authorization token in a case where the second authorization token a user of which is associated with a first authorization token to be deleted exists in authorization tokens stored in the storage unit when the first authorization token is to be deleted.

14. A system including a client apparatus, a server apparatus, and a user terminal apparatus,
wherein the client apparatus comprises a first transmission unit configured to transmit an authorization token acquisition request to the server apparatus;
wherein the server apparatus comprises:
a first receiving unit configured to receive the authorization token acquisition request from the client apparatus;
a determination unit configured to further determine a second client apparatus as a client apparatus of a transfer target of authority in a case where the second client apparatus associated with a first client apparatus exists when the first client apparatus is determined as the client apparatus of the transfer target of the authority based on client information of the client apparatus included in the authorization token acquisition request received by the first receiving unit;
a generation unit configured to generate a permission screen corresponding to a client apparatus determined as the client apparatus of the transfer target of the authority by the determination unit; and
a second transmission unit configured to transmit the permission screen generated by the generation unit to the user terminal apparatus; and
wherein the user terminal apparatus comprises:
a second receiving unit configured to receive the permission screen from the server apparatus; and
a display unit configured to display the permission screen received by the second receiving unit.

15. An information processing method executed by a server apparatus comprising:
further determining a second client apparatus as a client apparatus of a transfer target of authority in a case where the second client apparatus associated with a first client apparatus exists when the first client apparatus is determined as the client apparatus of the transfer target of the authority;
generating a permission screen corresponding to a client apparatus determined as the client apparatus of the transfer target of the authority in the determining; and
transmitting the permission screen generated in the generating.

16. An information processing method of a system including a client apparatus, a server apparatus, and a user terminal apparatus, the information processing method comprising:
transmitting, by the client apparatus in first transmitting, an authorization token acquisition request to the server apparatus;
receiving, by the server apparatus in first receiving, the authorization token acquisition request from the client apparatus;
further determining, by the server apparatus, a second client apparatus as a client apparatus of a transfer target of authority in a case where the second client apparatus associated with a first client apparatus exists when the first client apparatus is determined as the client apparatus of the transfer target of the authority based on client information of the client apparatus included in the authorization token acquisition request received in the first receiving;
generating, by the server apparatus, a permission screen corresponding to a client apparatus determined as the client apparatus of the transfer target of the authority in the determining;
transmitting, by the server apparatus in second transmitting, the permission screen generated in the generating to the user terminal apparatus;
receiving, by the user terminal apparatus in second receiving, the permission screen from the server apparatus; and
displaying, by the user terminal apparatus, the permission screen received in the second receiving.

17. A non-transitory computer-readable storage medium storing a program that causes a computer to function as respective units of the server apparatus according to claim 1.
